(19) United States
(12) Patent Application Publication
(10) Pub. No.: US 2010/0181390 A1
(43) Pub. Date: Jul. 22, 2010

(54) Cleaning tool

(75) Inventor: Kuan-Di Huang, Sanchong City (TW)

Correspondence Address: BACON & THOMAS, PLLC, 625 SLATERS LANE, FOURTH FLOOR, ALEXANDRIA, VA, 22314-1176, US

(73) Assignees: Kuan-Di Huang, Sanchong City (TW); Su-Shan Chen, Sanchong City (TW)

(21) Appl. No.: 12/654,053

(22) Filed: Dec. 9, 2009

(30) Foreign Application Priority Data
Jan. 22, 2009 (TW) 098201252

(51) Int. Cl. B05B 15/00

(52) U.S. Cl. 239/289

(57) ABSTRACT

A cleaning tool for cleaning dirt from a surface of an object includes a body having a containing space for filling a cleaning liquid and a recess and an opening disposed on a surface of the body, a spray head including a nozzle portion passing through a cap, which is covered and fixed onto the opening, and connected to a suction unit, which extends into the containing space for sucking and accessing the cleaning liquid, wherein a first lateral side of the wiping unit is movably attached and fixed to the recess, and a second lateral side of the wiping unit extends to the outside of the recess, so that a user can press the spray head to spray the cleaning liquid onto a surface of an object while wiping the surface of the object by using the second lateral side of the wiping unit.

### FIELD OF THE INVENTION

The present invention relates to a cleaning tool for cleaning dirt on a surface of an object, more particularly to a cleaning tool that integrates a wiping unit and a body for containing a cleaning liquid and allows users to spray the cleaning liquid on a surface of an object while wiping the surface of the object.

### BACKGROUND OF THE INVENTION

As a cleaning job for keeping our living environment clean is an inevitable activity of our daily life, cleaning tools become indispensible to us, and present existing cleaning tools including brooms, mops, wipers and the like come with a single function only. When we perform a cleaning job, we generally need to use different cleaning tools of different functions alternately to meet the requirements of cleaning different areas or objects. For example, when a user wants to clean a computer casing, the user generally has to go through the procedure of preparing a cleaning liquid bottle and a wiper, spraying the cleaning liquid on the computer casing, wiping the computer casing by the wiper, and repeating the same procedure for several times. In the traditional cleaning procedure, a user generally holds the computer casing by one hand and the wiper by another hand to wipe a surface of the computer casing sprayed with the cleaning liquid. When the user wants to spray the cleaning liquid again, then the user needs to find and hold the cleaning liquid bottle, and thus the user has to carry the cleaning liquid bottle at an easy-to-reach position, but the user usually forgets or neglects the position where the cleaning liquid bottle is put, and may even kick or turn over the cleaning liquid bottle accidentally to make the environment dirtier. Furthermore, the wiper and the cleaning liquid bottle are separated, such that after the cleaning job is finished, the user generally stores the wiper and the cleaning liquid bottle separately. As a result, it takes some time for the user to find the wiper and the cleaning liquid bottle again for the next cleaning job, and thus causes tremendous inconvenience to the user.

In summation of the description above, the traditional wiper and cleaning tool have many drawbacks and cause inconvenience to users and give a low cleaning efficiency. Therefore, it is an important subject for the present invention to design a cleaning tool to overcome the foregoing problems and achieve the effects of avoiding the cleaning liquid from hurting the user's hand, facilitating the storage and access of the cleaning tool, and reducing contaminations caused by toppling over the cleaning liquid bottle.

### SUMMARY OF THE INVENTION

In view of the shortcomings of the conventional cleaning tools including the inconvenient access and storage, and the risk of toppling over or sliding down the cleaning liquid bottle easily, the inventor of the present invention based on years of experience in the related industry to conduct extensive researches and experiments, and finally developed a cleaning tool in accordance with the present invention, in hope of overcoming the aforementioned shortcomings of the prior art effectively.

Therefore, it is a primary objective of the present invention to provide a cleaning tool, comprising a body, a spray head and a wiping unit. The body includes a containing space for containing a specific amount of cleaning liquid, and the body further includes a recess and an opening disposed on a surface of the body. The spray head includes a suction unit, a cap and a nozzle portion, wherein the nozzle portion is passed through the cap and connected to the suction unit, and the cap is covered and fixed onto the opening, such that the suction unit can be extended into the containing space for sucking and accessing the cleaning liquid, and the nozzle portion is exposed outside the body, a first lateral side of the wiping unit is movebly attached and fixed to the recess, and a second lateral side of the wiping unit opposite to the first lateral side extends to the outside of the recess, such that after a user fills the cleaning liquid into the containing space of the body through the opening, the user can press the spray head to suck and access the cleaning liquid by the suction unit and spray the cleaning liquid to a surface of an object through the nozzle portion. In the meantime, the user can use the second lateral side of the wiping unit to wipe the surface of the object covered by the cleaning liquid immediately. The present invention not only allows users to access and use the cleaning liquid and the wiping unit and saves the user's time for the cleaning job while reducing the space of placing the cleaning liquid and the wiping unit, but also facilitates users to change and use cleaning liquids and wiping units of different applications to meet the requirements for cleaning different surfaces and different levels of dirt of the desired cleaning object and achieve the effects of cleaning dirt thoroughly as well as saving the user's time.

### BRIEF DESCRIPTION OF THE DRAWINGS

FIG. 1 is an exploded view of a first preferred embodiment of the present invention; and

FIG. 2 is an exploded view of a preferred embodiment of the present invention.

### DETAILED DESCRIPTION OF THE PREFERRED EMBODIMENTS

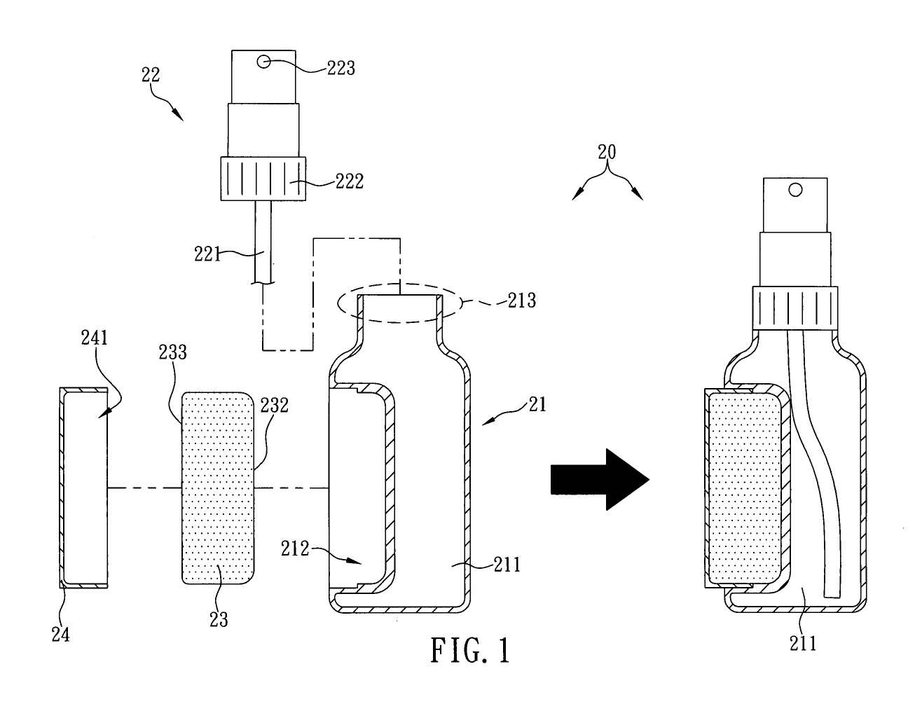

With reference to FIG. 1 for a cleaning tool for cleaning dirt on a surface of an object in accordance with a first preferred embodiment of the present invention, the cleaning tool 20 comprises a body 21, a spray head 22 and a wiping unit 23, wherein the body 21 includes a containing space 211 for containing a specific amount of cleaning liquid, and the body 21 further includes a recess 212 and an opening 213 disposed on a surface of the body 21, wherein the opening 213 is disposed at an upper end of the body 21. The spray head 22 includes a suction unit 221, a cap 222 and a nozzle portion 223, wherein the nozzle portion 223 is passed through the cap 222 and coupled to the suction unit 221, and the cap 222 is covered and fixed to the opening 213, such that the suction unit 221 can be extended into the containing space 211 for sucking and accessing the cleaning liquid, and the nozzle portion 223 is exposed outside the body 21, and a first lateral side 232 of the wiping unit 23 is movebly attached and fixed to the recess 212 of the body 21 and a second lateral side 233 of the wiping unit 23 opposite to the first lateral side 232 extends to the outside of the recess 212, such that after a user fills the cleaning liquid into the containing space 211 of the body 21 through the opening 213, the user can press the spray head 22 to suck and access the cleaning liquid by the suction unit 221 and spray the cleaning liquid onto a surface (such as a screen or a tabletop) of an object from the nozzle portion 223. In the meantime, the user can use the second lateral side 233 of the wiping unit 23 to wipe the surface of the object covered with the cleaning liquid. The invention not only allows users to access and use the cleaning liquid and the wiping unit 23 at the same time to save the user's time for the cleaning job while reducing the space of placing the cleaning liquid and the wiping unit 23, but also facilitates users to change and use cleaning liquids and wiping units 23 for different applications to meet the requirements of cleaning different surfaces or dirt levels of the desired cleaning object, and achieve the effects of cleaning dirt thoroughly and saving the user's time.

In the first preferred embodiment as shown in FIG. 1, the cleaning tool 20 further comprises a cover 24 capable of being engaged with the recess 212 and having a containing cavity 241 disposed on a lateral side of the cover 24 for accommodating and fixing the second lateral side 233 of the wiping unit 23, so that a user can remove the wiping unit 23 and the cover 24 from the recess 212 of the body 21 easily, and hold the cover 24 by a hand to use the first lateral side 232 of the wiping unit 23 to wipe a surface of an object. After the user finishes the cleaning job, the user can use the cover 24 to put the first lateral side 232 of the wiping unit 23 into the recess 212 and then cover the wiping unit 23 completely while a periphery of the cover 24 adjacent to the containing cavity 241 is connected tightly with an internal edge of the recess 212. Thus, when the cleaning tool 20 is stored or not in use, it is able to prevent dusts in the air from attaching onto the wiping unit 23 and affecting the cleaning effect of the cleaning tool 20.

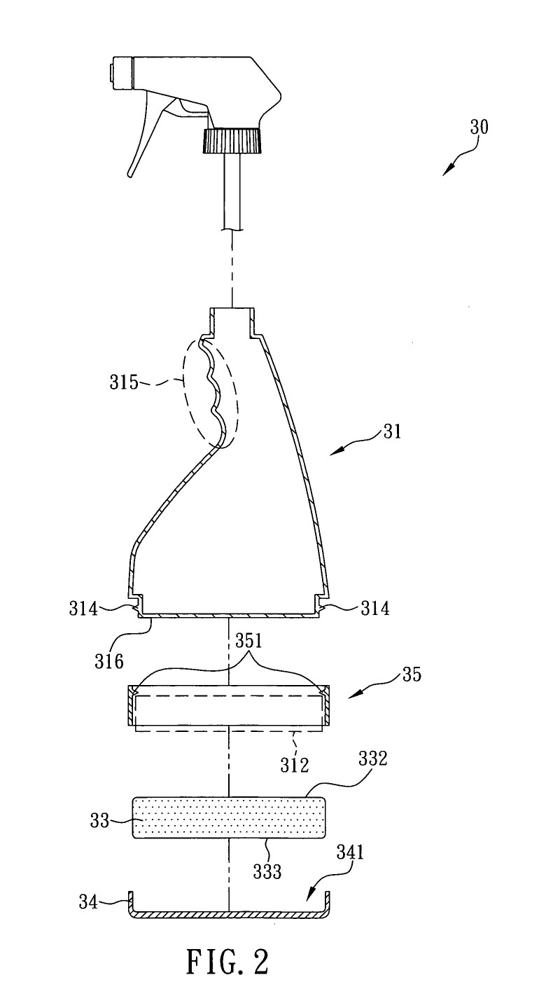

With reference to FIG. 2 for a second preferred embodiment of the present invention, a first latch element 314 is disposed around a bottom side 316 of the body 31, and the cleaning tool 30 further comprises a ring 35, and the ring 35 includes a second latch element 351 disposed around an internal side of the ring 35 and latched with the first latch element 314, such that the ring 35 can be fixed to the bottom side 316 of the body 31, and the body 31 and the ring 35 are latched to form a recess 312 on the bottom side of the body 31 for accommodating a first lateral side 332 of the wiping unit 33 and enabling a second lateral side 333 of the wiping unit 33 opposite to the first lateral side 332 to extend outside of the recess 312, and the first lateral side 332 of the wiping unit 33 can be attached and fixed to the recess 312 of the body 31.

In the second preferred embodiment as shown in FIG. 2, the cleaning tool 30 further comprises a cover 34, and a containing cavity 341 disposed on a lateral side of the cover 34 for accommodating and fixing the second lateral side 333 of the wiping unit 33, such that after a user finishes the cleaning job, the user can use the cover 34 to cover the second lateral side 333 of the wiping unit 33 completely to prevent dusts in the air from attaching onto the second lateral side 333 of the wiping unit 33 and affecting the cleaning effect of the cleaning tool, when the cleaning tool is stored or not in use.

In the second preferred embodiment as shown in FIG. 2, the body 31 further comprises a holding portion 315 integrally formed with the body 31, such that users can hold the holding portion 315 by a hand to facilitate using the cleaning tool 30.

In the second preferred embodiment as shown in FIG. 2, an adhesive connecting layer (which is a double-side adhesive tape or glue in this preferred embodiment) is disposed between the second lateral side 333 of the wiping unit 33 and the containing cavity 341 of the cover 34, so that the second lateral side 333 of the wiping unit 33 can be adhered into the containing cavity 341 securely.

However, a set of mutually attracted magnets, a set of magnet and iron plate, or a set of mutually adhered Velcro tapes can be used between the second lateral side 333 of the wiping unit 33 and the containing cavity 341, or between the first lateral side 332 of the wiping unit 33 and the recess 312 in other preferred embodiments of the present invention, such that after the wiping unit 33 and the containing cavity 341 or the wiping unit 33 and the recess 312 are attached, the installed magnets, iron plate or Velcro tapes can be attracted or adhered with one another to secure the wiping unit 33 with the containing cavity 341 or the wiping unit 33 with the recess 312. It is noteworthy to point out that the invention is not limited to the adhesion method only.

While the invention herein disclosed has been described by means of specific embodiments, numerous modifications and variations could be made thereto by those skilled in the art without departing from the scope and spirit of the invention set forth in the claims.

What is claimed is:

1. A cleaning tool, comprising:
a body, including a containing space therein, for filling and containing a cleaning liquid, and a recess and an opening disposed on a surface of the body, and the opening being interconnected to the containing space;
a spray head, including a suction unit, a cap and a nozzle, and the nozzle being passed through the cap and coupled to the suction unit, and the cap being covered onto and fixed to the opening, and the suction unit being accommodated in the containing space for sucking and accessing the cleaning liquid, and the nozzle being exposed outside the body, and capable of spraying out the cleaning liquid sucked by the suction unit when the spray head is pressed; and
a wiping unit, having a first lateral side movably attached and fixed to the recess and a second lateral side opposite to the first lateral side extending outside of the recess.

2. The cleaning tool of claim 1, further comprising a cover having a containing cavity disposed on a lateral side of the cover for accommodating and fixing the second lateral side of the wiping unit, such that the cover can be covered onto the second lateral side of the wiping unit completely.

3. The cleaning tool of claim 2, wherein a periphery of the cover adjacent to the containing cavity is connected tightly with an internal edge of the recess.

4. The cleaning tool of claim 3, wherein the cleaning tool includes a holding portion integrally formed with the body.

5. The cleaning tool of claim 4, wherein the wiping unit and the recess respectively include at least one set of Velcro tapes adhered to one another.

6. A cleaning tool, comprising:
a body, including a containing space therein for filling and containing a cleaning liquid, an opening disposed on a surface of the body and interconnected to the containing space, and a first latch element disposed around a bottom side of the body;
a spray head, including a suction unit, a cap and a nozzle, and the nozzle being passed through the cap and coupled to the suction unit, and the cap being covered onto and fixed to the opening, and the suction unit being accommodated in the containing space for sucking and accessing the cleaning liquid, and the nozzle being exposed outside the body, and capable of spraying out the cleaning liquid sucked by the suction unit when the spray head is pressed; and
a ring, including a second latch element disposed thereon and around an internal side of the ring and latched with the first latch element for fixing the ring to the body to form a recess on the bottom side of the body; and
a wiping unit, having a first lateral side movably attached and fixed to the recess and a second lateral side opposite to the first lateral side extending outside of the recess.

7. The cleaning tool of claim 6, further comprising a cover having a containing cavity disposed on a lateral side of the cover for accommodating the second lateral side of the wiping unit, such that the cover can be covered onto the second lateral side of the wiping unit completely.

8. The cleaning tool of claim 7, wherein a periphery of the cover adjacent to the containing cavity is connected tightly with an internal edge of the recess.

9. The cleaning tool of claim 8, wherein the cleaning tool includes a holding portion integrally formed with the body.

10. The cleaning tool of claim 9, wherein the wiping unit and the recess respectively include at least one set of Velcro tapes adhered to one another.
